(19) United States
(12) Patent Application Publication
(10) Pub. No.: US 2022/0258178 A1
(43) Pub. Date: Aug. 18, 2022

(54) FLOTATION CELL

(71) Applicant: Metso Outotec Finland Oy, Tampere (FI)

(72) Inventor: Antti Rinne, Espoo (FI)

(73) Assignee: Metso Outotec Finland Oy, Tampere (FI)

(21) Appl. No.: 17/627,933

(22) PCT Filed: Jul. 29, 2019
(86) PCT No.: PCT/FI2019/050568

§ 371 Date: Jan. 18, 2022

(51) Int. Cl. B03D 1/14; B03D 1/16; B03D 1/24

(52) U.S. Cl. CPC B03D 1/1456; B03D 1/1462; B03D 2203/02; B03D 1/24; B03D 1/1406; B03D 1/16

(57) ABSTRACT

A flotation cell for treating particles suspended in slurry. The flotation cell includes a fluidized bed, a recovery zone at the upper part of the flotation cell, a launder lip and a recovery launder, and a tailings outlet. A primary slurry feed including fresh slurry is arranged to be fed into the flotation cell by a first feed inlet at a first position; and a secondary slurry feed including at least slurry recirculated from a flotation cell is arranged to be fed into the fluidized bed by a second feed inlet at a second position, below the first position. The slurry recirculated from the flotation cell is obtained at a third position between the recovery launder and the tailings outlet. A use of the flotation cell as well as a method for treating particles suspended in slurry are also disclosed.

### TECHNICAL FIELD

The current disclosure relates to a flotation cell and a method for separating valuable material containing particles from particles suspended in slurry, and to use of the flotation cell.

### SUMMARY OF THE INVENTION

The flotation cell according to the current disclosure is characterized by what is presented in claim 1.

Use of the flotation line according to the current disclosure is characterized by what is presented in claim 34.

The flotation method according to the current disclosure is characterized by what is presented in claim 36.

The flotation cell according to the invention is intended for treating particles suspended in slurry and for separating the slurry into underflow and overflow. The flotation cell comprises a fluidized bed formed by fluid feed configured to supply a fluid to the flotation cell, and by a flotation gas feed configured to supply flotation gas, in which fluidized bed flotation gas bubbles adsorb to hydrophobic particles to form bubble-particle agglomerates that rise towards the top of the flotation cell; a recovery zone at an upper part of the flotation cell, configured to collect the bubble-particle agglomerates rising in the fluidized bed; a launder lip and a recovery launder arranged at the top of the flotation cell, and arranged to remove particles collected in the recovery zone from the flotation cell as overflow; and a tailings outlet arranged below the recovery launder and arranged to remove non-collected particles descending from the recovery zone as underflow. The flotation cell has a height measured from the bottom of the flotation cell to the launder lip. The flotation cell is characterized in that a primary slurry feed comprising fresh slurry is arranged to be fed into the flotation cell by a first feed inlet at a first position within an upper 50% of the flotation cell height and higher than the tailings outlet; and in that a secondary slurry feed comprising at least slurry recirculated from a flotation cell is arranged to be fed into the fluidized bed by a second feed inlet at a second position below the first position, so as to contribute to the formation of the fluidized bed, the slurry recirculated from the flotation cell obtained at a third position between the recovery launder and the tailings outlet.

According to an aspect of the invention, use of the flotation line according to the invention is disclosed for recovering particles comprising a valuable material suspended in slurry.

According to a further aspect of the invention, a method is disclosed for treating particles suspended in slurry and for separating the slurry into underflow and overflow in a flotation cell according to the invention. The method is characterized by feeding a primary slurry feed comprising fresh slurry into the flotation cell via a first feed inlet; feeding a secondary slurry feed comprising at least slurry recirculated from a flotation cell into a fluidized bed via a second feed inlet so as to contribute to the formation of the fluidized bed; and by obtaining the slurry recirculated from the flotation cell at a third position between a recovery launder and a tailings outlet.

With the invention described herein, the recovery in a flotation process of particles displaying a variety of size distribution may be improved. The recovery of coarse particles may be improved at the same time as ensuring the recovery of fine particles in one flotation cell and one operational stage. The particles may, for example, comprise mineral ore particles such as particles comprising a metal or some other valuable material. By feeding the primary slurry feed comprising coarser particles at a carefully selected part of the flotation cell, there is more time for flotation gas bubbles to adhere to the particles within the fluidized bed, before the upwards flow carries the material into the recovery zone. At the same time, amount of water or fluid required to form and maintain the fluidized bed may be decreased, and the physical wear of the various flotation cell parts such as feed inlets by the coarser particles reduced. The flotation cell can be realized as a simpler structure with a substantially level bottom, which may save space at flotation sites.

In froth flotation for mineral ore, upgrading the concentrate is directed to an intermediate particle size range between 40 μm to 150 μm. Fine particles are thus particles with a diameter of 0 to 40 μm, and coarse particles have a diameter greater than 150 μm. Ultrafine particles can be identified as falling in the lower end of the fine particle size range.

Recovering very coarse or very fine particles is challenging, as in conventional flotation cells, fine particles are not easily entrapped by flotation gas bubbles and may therefore become lost in the tailings. Typically in froth flotation, flotation gas is introduced into a flotation cell or tank via a mechanical agitator or by some other gas feed arrangement. The thus generated flotation gas bubbles have a relatively large size range, typically from 0.8 to 2.0 mm, or even larger, and are not particularly suitable for collecting particles having a finer particle size.

Fine particle recovery may be improved by increasing the number of flotation cells within a flotation line, or by recirculating the once-floated material (overflow) or the tailings flow (underflow) back into the beginning of the flotation line, or to precedent flotation cells. A cleaner flotation line may be used in order to improve especially grade, also for fine particles. In addition, a number of flotation arrangements employing fine flotation gas bubbles or even so-called microbubbles have been devised. There are also different types of flotation cells employing fluidized beds for entrapping the desired particles and creating an upwards flow of flotation gas bubble-particle agglomerates within the flotation cell so as to transport the desired particles into a froth layer to be recovered into overflow.

Column flotation cells act as three phase settlers where particles move downwards in a hindered settling environment counter-current to a flow of rising flotation gas bubbles generated by spargers located near the bottom of the cell. While column flotation cells may improve the recovery of finer particles, the particle residence time is dependent on settling velocity, which may impact on the flotation of large particles. In other words, while there may be a beneficial effect for recovery of fine particles, the overall flotation performance (recovery of all valuable material, grade of recovered material) may be undermined by the negative effect on recovery of larger particles.

Conventional flotation cells employing a fluidized bed may not be ideal for recovering coarse particles. For example, the fresh slurry feed may be arranged so that the risk of coarse particles causing wear of feed inlet/inlets or blocking up the feed inlet/inlets increases, thereby causing downtime and costs in maintenance. On the other hand, conventional fluidized bed flotation cells often require the slurry feed to be classified or fractionated to remove fine particles that would hinder the intended operation of the flotation cell. With the flotation cell according to the invention, fresh slurry feed may comprise slurry directly from grinding, i.e. classification of slurry is not necessarily required, which may make it possible to decrease energy consumption, especially if cyclone classification can be foregone, save space within the flotation arrangement, as well as obtain savings in operational costs.

It is also possible to treat underflow or tailings flow of some suitable flotation cell or circuit in the flotation cell according to the invention, by leading it into the flotation cell as primary slurry feed. Further, it may be possible to increase the coarseness in grinding, i.e. decrease the grinding level and so gain savings in grinding energy. For example, by increasing the particle size of ground material from conventional 100 to 200 μm to 300 μm, energy consumption may be decreased up to 50% in the grinding step. At the same time, recovery of the valuable particles displaying a coarser particle size distribution, may still be improved, and the above-mentioned negative effects on the flotation equipment avoided.

By combining a primary slurry feed and a separate secondary slurry feed according to the present invention, the aforementioned negative effects may be alleviated. The primary slurry feed comprising fresh slurry, that is slurry comprising particles displaying a size range including coarser particles, is arranged to be fed into the upper half of the flotation cell; and the secondary slurry feed comprising recirculated slurry with a particle size range different from that of the primary slurry feed, and, in some cases, with a greater fraction of finer particles, is arranged to be fed into the fluidized bed so as to contribute to the formation of the fluidized bed, utilising slurry recirculated from the flotation cell, or another flotation cell, and obtained at a position between the recovery launder and the tailings outlet, at least in the case the slurry is recirculated from the same flotation cell as it is recirculated to.

The coarser particles are thereby delivered to a position advantageous for their recovery into the froth layer, and there is no need to attempt entrapping coarser particles at the bottom part of the flotation cell. This may be ineffective due to the relatively long ascend causing drop-back of particles comprising valuable material. A smaller hydraulic fluid volume may be needed to form and maintain the fluidized bed as the coarser particles do not need to be brought up through the fluidized bed, but the collisions between flotation gas bubbles and coarser particles needed to form the bubble-particle agglomerates take place at the pulp at the top part of the fluidized bed and in the recovery zone. At the same time, since coarse particles are not delivered into the flotation cell via the fluid feed or other such arrangement near the bottom of the flotation cell, the fluid feed does not become blocked or worn by the ore particles.

The flotation cell can be realized as a simpler structure—for example, no conical or funnel-form bottom structure is required for collecting non-collected particles, nor are any maintenance or cleaning hatches needed in the lower part of the flotation cell for cleaning the build-up of sludge from the bottom of the cell.

On the other hand, the finer particles become efficiently entrapped by flotation gas bubbles within the fluidized bed part of the flotation cell. To further increase the efficiency of fine particle recovery, the secondary slurry feed comprises recirculated slurry, which may be recirculated from the same flotation cell, or equally, from another flotation cell within the flotation arrangement or plant of which the flotation cells are a part. The secondary slurry feed may thus comprise a recirculated fraction of slurry that has a desired particle size range. The recirculated fraction may also originate from classification or fractionation. These kinds of fine particles do not necessary rise into the froth layer, but may remain circulating in the uppermost part of the fluidized bed and/or in the recovery zone. By obtaining the recirculated fraction of slurry from a location within this part of the flotation cell, the unrecovered fine particles may be efficiently treated and recovered within the flotation cell.

At the same time, with the secondary slurry feed, arranged to be fed into the fluidized bed, it may be possible to obtain savings in water: the amount fluid needed to form and maintain the fluidized bed may be decreased as additional fluid is brought into the fluidized bed by the secondary slurry feed which also contributes to the formation of the fluidized bed. Utilising a slurry recirculated from the flotation cell also promotes maintaining the mass balance within the flotation cell.

The flotation cell, its use and the method according to the invention have the technical effect of allowing the flexible recovery of various particle sizes, as well as efficient recovery of valuable mineral containing ore particles from poor ore raw material with relatively low amounts of valuable mineral initially.

By treating the slurry according to the present invention as defined by this disclosure, recovery of valuable material containing particles may be increased. The initial grade of recovered material may be lower, but the material (i.e. slurry) is also thus readily prepared for further processing, which may include for example regrinding and/or cleaning.

In this disclosure, the following definitions are used regarding flotation.

Basically, flotation aims at recovering a concentrate of ore particles comprising a valuable mineral. By concentrate herein is meant the part of slurry recovered in overflow or underflow led out of a flotation cell. By valuable mineral is meant any mineral, metal or other material of commercial value.

Flotation involves phenomena related to the relative buoyancy of objects. The term flotation includes all flotation techniques. Froth flotation is a process for separating hydrophobic materials from hydrophilic materials by adding gas, for example air or nitrogen or any other suitable medium, to the process. Froth flotation could be made based on natural hydrophilic/hydrophobic difference or based on hydrophilic/hydrophobic differences made by addition of a surfactant or collector chemical. Gas can be added to the feedstock subject of flotation (slurry or pulp) by a number of different ways.

A flotation cell meant for treating mineral ore particles suspended in slurry by flotation. Thus, valuable metal-containing ore particles are recovered from ore particles suspended in slurry.

By a flotation cell is herein meant a tank or vessel in which a step of a flotation process is performed. A flotation cell is typically cylindrical in shape, the shape defined by an outer wall or outer walls. The flotation cells regularly have a circular cross-section. The flotation cells may have a polygonal, such as rectangular, square, triangular, hexagonal or pentagonal, or otherwise radially symmetrical cross-section, as well. The number of flotation cells may vary according to a specific flotation line and/or operation for treating a specific type and/or grade of ore, as is known to a person skilled in the art.

In a flotation cell employing a fluidized bed, air or other flotation gas bubbles which are dispersed by the fluidization system percolate through the hindered-settling zone and attach to the hydrophobic component altering its density and rendering it sufficiently buoyant to float and be recovered in a recovery zone. Fluid, for example water, or comprising water, is fed into the lower part of the fluidized bed or the flotation cell at a desired rate to form and maintain the fluidized bed.

By overflow herein is meant the part of the slurry collected into the launder of the flotation cell and thus leaving the flotation cell. Overflow may comprise froth, froth and slurry, or in certain cases, only or for the largest part slurry, as would be the case if the flotation cell was operated with virtually no froth layer, i.e. as a overflow flotation cell. In some embodiments, overflow may be an accept flow containing the valuable material particles collected from the slurry.

By underflow herein is meant the fraction or part of the slurry which is not floated into the surface of the slurry in the flotation process within the recovery zone, leaving a flotation cell via an outlet, i.e. a tailings outlet or tailings launder, which in the case of a fluidized bed flotation cell is typically located at a vertex of the bottom funnel, but may also be located at the uppermost part of the fluidized bed section, surrounding the perimeter of the section. Equally, the tailings outlet could be realized as an outlet arranged at the sidewall of the flotation cell, for example at the lower part of the flotation cell, even under the fluidized bed. The rejected particles drop back down in the recovery zone, on top of the fluidized bed and are transported into the tailings outlet or tailings outlet as is known in the art.

By concentrate herein is meant the floated part or fraction of slurry of ore particles comprising a valuable mineral.

In an embodiment of the flotation cell according to the invention, the recovery zone is arranged above the fluidized bed.

In an embodiment, the recovery zone is arranged at an upper part of the fluidized bed.

In an embodiment, the primary slurry feed is arranged to be fed into the flotation cell at a position within an upper 30% of the flotation cell height.

In an embodiment, the primary slurry feed is arranged to be fed into the recovery zone.

By arranging the primary slurry feed as described above, the particles may become efficiently entrapped by flotation gas bubbles within the fluidized bed part of the flotation cell.

In an embodiment, the first feed inlet is arranged at the centre of the flotation cell.

In a further embodiment, the first feed inlet comprises a circular section arranged to distribute the primary slurry feed evenly around the centre of the flotation cell.

By arranging the feed inlet for the primary slurry feed at the centre of the flotation cell, advantageously so that the feed inlet may evenly distribute the primary slurry feed around the centre of the flotation cell, the risk of valuable material comprising coarse particles ending up in the tailings may be decreased. The flotation gas bubbles may have more time to adhere to the valuable material comprising particles and the thus-formed bubble-particle agglomerates may have more time to begin their ascend to the froth layer before the slurry migrates towards the tailings outlet.

In an embodiment, the primary slurry feed is arranged to be fed into the fluidized bed so that the primary slurry feed has a flow direction counter-current to the rising bubble-particle agglomerates.

By arranging the primary slurry feed to be fed into the flotation cell and fluidized bed so that the flow of primary slurry feed is against the flow of fluid from the fluid feed and thus divergent from the rising bubble-particle agglomerates within the fluidized bed, it may be possible to create favourable forces which contribute to the mixing of the flotation gas bubbles and particles, and increase the collisions between the bubbles and the particles, thus increasing the probability of bubble-particle agglomeration formation and improving recovery of particles comprising valuable material.

In an embodiment, the first feed inlet comprises a sparger.

In a further embodiment, the primary slurry feed is arranged to be fed into the fluidized bed from a perimeter of the flotation cell so that the primary slurry feed has a flow direction substantially perpendicular to the rising bubble-particle agglomerates.

By “substantially perpendicular” herein is meant that initially, at the exact point of entry of the primary slurry feed into the flotation cell, the flow direction is perpendicular in relation to the rising bubble-particle agglomerates, but almost instantaneously, the flow will start to deviate from its initial perpendicular direction due to the upwards flow of the rising bubble-particle agglomerates in the slurry within the flotation cell.

In a further embodiment, the first feed inlet comprises a sparger assembly arranged into a sidewall of the flotation cell, the sparger assembly arranged to create flotation gas bubbles, to cause attachment of flotation gas bubbles onto particles in the primary slurry feed, and to introduce the primary slurry feed into the fluidized bed.

In yet another embodiment, the sparger assembly is arranged radially around a perimeter of the flotation cell.

In a further embodiment, the sparger assembly comprises jetting spargers, or cavitation spargers, or Venturi spargers.

By disposing a sparger or a number of spargers into a flotation cell according to the invention, the probability of collisions between flotation gas bubbles, as well as between gas bubbles and particles may be increased. Having a number of spargers may ensure an improved distribution of flotation gas bubbles within a flotation cell, and the bubbles exiting the blast tubes are distributed evenly throughout the flotation cell, the distribution areas of individual spargers have the possibility of intersecting each other and converging, thus promoting an extensively even flotation gas bubble distribution into the flotation cell, which in turn may affect the recovery of particles comprising valuable material beneficially, and also contribute to the aforementioned even and thick froth layer. When there are several spargers, collisions between flotation gas bubbles and/or particles in the slurry infeed from spargers are promoted as the different flows intermingle and create local mixing subzones. As the collisions are increased, more bubble-particle agglomerates are created and captured into the froth layer, and therefore recovery of valuable material may be improved.

By generation of fine flotation gas bubbles, by bringing them into contact with the particles, and by controlling the flotation gas bubble-particle agglomerates-liquid mixture of slurry, it may be possible to maximize the recovery of hydrophobic particles into the recovery zone and into the flotation cell overflow or concentrate, thus increasing the recovery of desired material irrespective of its particle size distribution within the slurry.

The number of spargers directly influences the amount of flotation gas that can be dispersed in the slurry. In conventional froth flotation, dispersing an increasing amount of flotation gas would lead to increased flotation gas bubble size. For example, in a Jameson cell, an air-to-bubble ratio of 0.50 to 0.60 is utilized. Increasing the average bubble size will affect the bubble surface area flux (S_{b}) detrimentally, which means that recovery may be decreased. In a flotation cell according to the invention, with spargers, significantly more flotation gas may be introduced into the process without increasing the bubble size or decreasing S_{b}, as the flotation gas bubbles created into the slurry infeed remain relatively small in comparison to the conventional processes. On the other hand, by keeping the number of spargers as small as possible, costs of refitting existing flotation cells, or capital expenditure of setting up such flotation cells, may be kept in check without causing any loss of flotation performance of the flotation cells.

By arranging a sparger assembly evenly and radially around the perimeter of the flotation cell, the introduction of primary slurry feed may be achieved evenly throughout the flotation cell, which improves the flotation efficiency further. Spargers may, at the same time as acting as a feed inlet, serve in providing flotation gas feed into the flotation cell, for example by introducing flotation gas bubbles, e.g. fine bubbles or microbubbles directly into the slurry as it is delivered into the flotation cell via the spargers of the sparger assembly.

By microbubbles herein is meant flotation gas bubbles falling into a size range of 1 μm to 1.2 mm, introduced into the slurry by a specific microbubble generator. More specifically, depending on the manner in which the microbubble generator is arranged, the majority of the microbubbles fall within a specific size range.

Jetting spargers may be utilized around the perimeter of the flotation cell for the infeed of primary slurry feed as well as direct introduction of microbubbles with a size range of 0.5 to 1.2 mm into the slurry. Especially if microbubbles are introduced in to the fluidized bed, they may have higher probability of colliding with finer particles in the mixing zone, thus improving the reporting of also those particles into the froth zone. Cavitation spargers or Venturi spargers may be utilized to introduce primary slurry feed, additional fluid, e.g. water, and air or other flotation gas into the flotation cell by arranging cavitation spargers around the perimeter of the flotation cell. Cavitation spargers may be used to introduce microbubbles with a size range of 0.3 to 0.9 mm. Flotation air/gas, or flotation air/gas and water, respectively, can be introduced into the spargers to create microbubbles with a size range of 0.3 to 1.2 mm, injected directly into the flotation cell. The microbubbles may especially attach to the finer mineral ore particles, while the “normal” flotation gas bubbles present in the fluidized bed adhere to coarser particles. Thereby, an increase the overall recovery of valuable mineral may be achieved.

In contrast, “normal” flotation gas bubbles utilized in froth flotation display a size range of approximately 0.8 to 2 mm, and are introduced into the slurry by or via a mechanical agitator or by/via flotation gas inlet(s). Furthermore, these flotation gas bubbles may have a tendency to coalesce into even larger bubbles during their residence in the mixing zone where collisions between mineral ore particles and flotation gas bubbles, as well as only between flotation gas bubbles take place. As microbubbles are introduced into a flotation cell outside the turbulent mixing zone, such coalescence is not likely to happen with microbubbles, and their size may remain smaller throughout their residence in the flotation cell, thereby affecting the ability of the microbubble to catch fine ore particles.

In an embodiment, the fluid feed comprises flotation gas feed.

In an embodiment, the second feed inlet comprises a flotation gas feed.

By arranging flotation gas feed into the flotation cell, the probability of collisions between flotation gas bubbles, as well as between gas bubbles and particles can be increased. Especially arranging a gas feed in connection with the second feed inlet, it may be possible to promote an extensively even flotation gas bubble distribution into the flotation cell, which in turn may affect the recovery of especially smaller particles beneficially, and also contribute to the formation of even and thick froth layer. As the collisions are increased, more bubble-particle agglomerates are created and captured into the froth layer, and therefore recovery of valuable material may be improved. By generation of fine flotation gas bubbles, by bringing them into contact with the particles, and by controlling the flotation gas bubble-particle agglomerates-liquid mixture of slurry, it may be possible to maximize the recovery of hydrophobic particles into the forth layer and into the flotation cell overflow or concentrate, thus increasing the recovery of desired material irrespective of its particle size distribution within the slurry. It may be possible to achieve a high grade for a part of the slurry stream, and at the same time, a high recovery. The flotation gas feed may be realized by any suitable manner known in the art. For example, spargers such as jetting spargers, cavitation spargers or Venturi spargers may be used, especially in connection with the secondary slurry feed and second feed inlet. It is also foreseeable that the flotation cell may comprise an agitator for producing flotation gas bubbles into the slurry. By an agitator herein is meant any suitable means for agitating slurry within the flotation cell, for example a mechanical agitator. The mechanical agitator may comprise a rotor-stator with a motor and a drive shaft, the rotor-stator construction arranged at the bottom part of the flotation cell.

In an embodiment, the secondary slurry feed is arranged to be fed into the fluidized bed so that the secondary slurry feed has a flow direction counter-current to the rising bubble-particle agglomerates.

In a further embodiment, the second feed inlet comprises a sparger.

By arranging the secondary slurry feed as described above, the finer particles may become efficiently entrapped by flotation gas bubbles within the fluidized bed part of the flotation cell.

By arranging the secondary slurry feed to be fed into the fluidized bed so that the flow of secondary slurry feed is against the flow of fluid from the fluid feed and thus divergent from the rising bubble-particle agglomerates within the fluidized bed, it may be possible to create favourable forces which contribute to the mixing of the flotation gas bubbles and particles, and increase the collisions between the bubbles and the particles, thus increasing the probability of bubble-particle agglomeration formation and improving recovery of particles comprising valuable material.

In an embodiment, the secondary slurry feed is arranged to be fed into the fluidized bed from the perimeter of the flotation cell so that the secondary slurry feed has a flow direction substantially perpendicular to the rising bubble-particle agglomerates.

By “substantially perpendicular” herein is meant that initially, at the exact point of entry of the secondary slurry feed into the flotation cell, the flow direction is perpendicular in relation to the rising bubble-particle agglomerates, but almost instantaneously, the flow will start to deviate from its initial perpendicular direction due to the upwards flow of the rising bubble-particle agglomerates in the slurry within the flotation cell.

In a further embodiment, the second feed inlet comprises a number of feed openings arranged into a sidewall of the flotation cell.

Such feed openings may be realized for example by spargers, which at the same time, serve as providing flotation gas feed into the flotation cell, as described above. The spargers may be cavitation spargers, jetting spargers or Venturi spargers. Also other forms of suitable feed openings known in the art are foreseeable.

In an embodiment, the secondary slurry feed is arranged to be fed into the fluidized bed so that the secondary slurry feed has a flow direction concurrent to the rising bubble-particle agglomerates.

In some instances, it may be advantageous to have a concurrent flow in the secondary slurry feed, so as not to disturb the fluidized bed.

In an embodiment, the second feed inlet comprises the fluid feed.

Limiting the number of individual inlets/parts of the flotation cell may lead to decreased costs in construction or remodelling of a flotation cell.

In an embodiment, the secondary slurry feed comprises slurry recirculated from the flotation cell via a recirculation circuit, and obtained at the third position which is arranged lower than the launder lip and higher than the first position at which the primary slurry feed is arranged to be fed into the flotation cell.

In an embodiment, the secondary slurry feed comprises slurry recirculated from the flotation cell via a recirculation circuit, and obtained at the third position which is arranged lower than the first position.

In an embodiment, the recovery zone comprises a froth layer at the top of the flotation cell.

In an embodiment, the primary slurry feed is arranged to be fed into the froth layer.

In an embodiment, the recovery zone comprises no froth layer and the flotation cell is arranged to be operated with constant slurry overflow.

In an embodiment, the recirculation circuit comprises a pump arranged to intake a slurry fraction from the third position and to forward the slurry fraction into the second feed inlet as secondary slurry feed.

In an embodiment, the recirculation circuit comprises a third feed inlet for introducing a feed of slurry into the secondary slurry feed prior to the secondary slurry feed being fed into the flotation cell via the second feed inlet.

In an embodiment, the secondary slurry feed comprises slurry recirculated from a further flotation cell separate to the flotation cell.

Secondary slurry feed may thus comprise a recirculated fraction of slurry that has a desired particle size range. Fine particles do not necessary rise into the froth layer, but may remain circulating in the recovery zone or in the upper part of the fluidized bed. By obtaining the recirculated fraction from a location within this section of the flotation cell, the unrecovered fine particles may be efficiently treated and recovered within the flotation cell.

The flotation process within the flotation cell according to the invention may be made more efficient when a part of the slurry within the flotation cell is recirculated back into the same flotation cell as secondary slurry feed via the second feed inlet.

By taking slurry from the above-defined parts of the flotation cell, it may be possible to ensure that the finer particles in that location may be efficiently reintroduced into the part of the flotation cell where active flotation process takes place. Thus the recovery rate of valuable material may be improved as the particles comprising even minimal amounts of valuable material may be collected into the concentrate.

It is also possible to treat slurry obtained from another flotation cell or flotation cells in order to increase the recovery of fine particles overall within a flotation line or arrangement of which the flotation cells are a part. Slurry feeds having similar particle size distributions or containing a certain amount of fine particles may thus be efficiently treated in the flotation cell according to the invention.

In an embodiment, the tailings outlet is arranged below the second feed inlet.

In an embodiment, the secondary slurry feed comprises fine particles having a P80 50% or less of the P80 of the primary slurry feed.

In an embodiment, the primary slurry feed comprises at least 20 w-% particles having a size of at least 300 μm.

In an embodiment, the flotation cell has a diameter of at least 1.0 m, preferably over 2 m, and most preferably between 2 and 8 m, at the height of the second position.

An embodiment of the use of the flotation cell according to the invention is intended in recovering particles comprising Cu from low grade ore.

A valuable mineral may be for example Cu, or Zn, or Fe, or pyrite, or metal sulfide such as gold sulfide. Mineral ore particles comprising other valuable mineral such as Pb, Pt, PGMs (platinum group metals Ru, Rh, Pd, Os, Ir, Pt), oxide mineral, industrial minerals such as Li (i.e. spodumene), petalite, and rare earth minerals may also be recovered, according to the different aspects of the present invention.

For example, in recovering copper from low grade ores obtained from poor deposits of mineral ore, the copper amounts may be as low as 0.1% by weight of the feed, i.e. infeed of fresh slurry into the flotation cell. The flotation cell according to the invention may be very practical for recovering copper, as copper is a so-called easily floatable mineral. In the liberation of ore particles comprising copper, it may be possible to get a relatively high grade from a single flotation process in the flotation cell.

By using the flotation cell according to the present invention, the recovery of such low amounts of valuable mineral, for example copper, may be efficiently increased, and even poor deposits cost-effectively utilized. As the known rich deposits have increasingly already been used, there is a need for processing the less favourable deposits as well, which previously may have been left unmined due to lack of suitable technology and processes for recovery of the valuable material in very low amounts in the ore.

### BRIEF DESCRIPTION OF THE DRAWINGS

The accompanying drawings, which are included to provide a further understanding of the current disclosure and which constitute a part of this specification, illustrate embodiments of the disclosure and together with the description help to explain the principles of the current disclosure. In the drawings:

FIGS. 1-5a, 5b present vertical cross-sectional views of embodiments of the flotation cell according to the invention; and

FIG. 6 shows two flotation cells of which at least one, flotation cell 1, is a flotation cell according to the invention.

### DETAILED DESCRIPTION

Reference will now be made in detail to the embodiments of the present disclosure, an example of which is illustrated in the accompanying drawing.

The description below discloses some embodiments in such a detail that a person skilled in the art is able to utilize the flotation cell, its use and the method based on the disclosure. Not all steps of the embodiments are discussed in detail, as many of the steps will be obvious for the person skilled in the art based on this disclosure.

For reasons of simplicity, item numbers will be maintained in the following exemplary embodiments in the case of repeating components. Directions of flow are indicated with arrows.

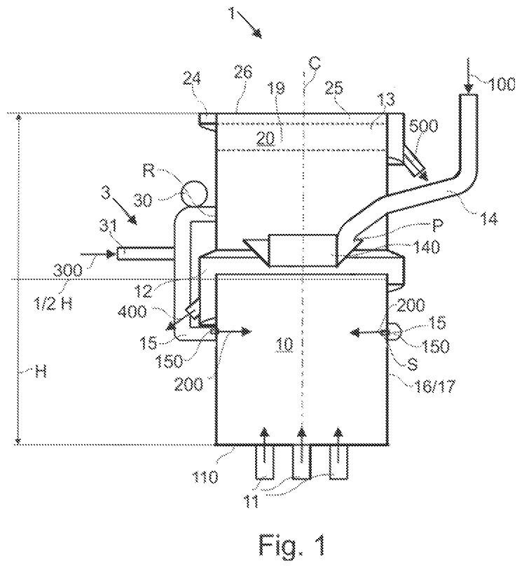

The enclosed FIGS. 1-6 illustrate a flotation cell 1 in some detail. The figures are not drawn to proportion, and many of the components of the flotation cell 1 are omitted for clarity.

The flotation cell 1 according to the invention is intended for treating mineral ore particles suspended in slurry and for separating the slurry into an underflow 400 and an overflow 500, the overflow 500 comprising a concentrate of a desired (valuable) mineral.

The flotation cell 1 comprises a fluidized bed 10 with a fluid feed 11 for supplying a fluid into the flotation cell to form and maintain a fluidized bed 10. In the fluidized bed 10, flotation gas bubbles adsorb to hydrophobic particles comprising valuable material to form bubble-particle agglomerates. The bubble-particle agglomerates rise toward an upper part 13 of the flotation cell 1 in the fluidized bed 10. The flotation cell 1 has a height H, measured from a bottom 110 of the flotation cell 1 to a launder lip 26.

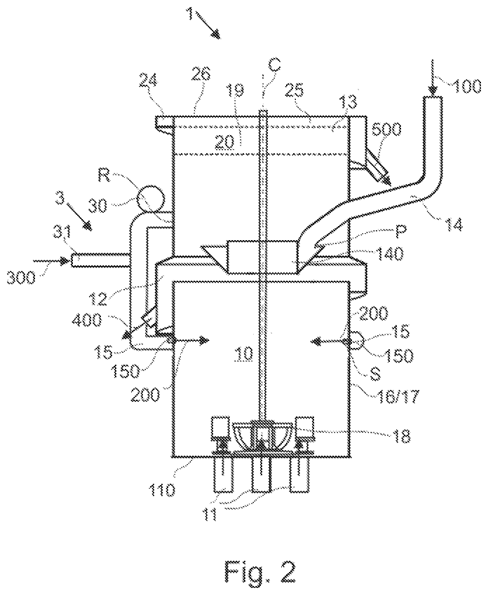

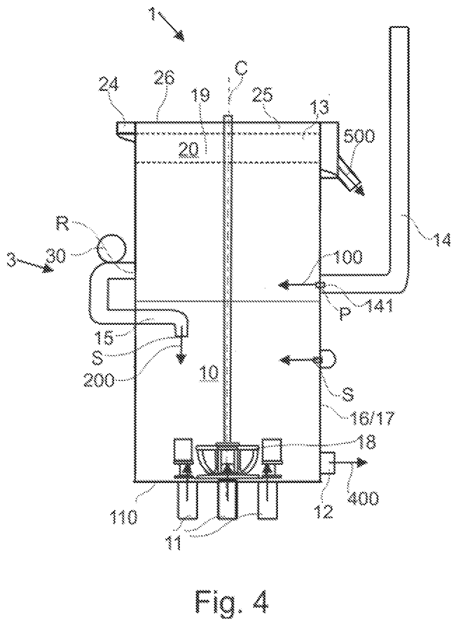

The flotation cell 1 comprises a flotation gas feed for supplying flotation gas. The flotation gas feed may, for example, be incorporated into the fluid feed 11. Alternatively or additionally, the flotation gas feed may be incorporated into a first feed inlet 14 which supplies a primary slurry feed 100 into the flotation cell 1. Alternatively or additionally, the flotation gas feed may be incorporated into a second feed inlet 15 which supplies a secondary slurry feed 200 into the fluidized bed 10. Alternatively or additionally, the flotation cell 1 may comprise a flotation gas feed in the form of an agitator 18, for example a mechanical mixer comprising a rotor-stator assembly, disposed adjacent, i.e. at or near, the bottom 110 of the flotation cell 1, below the fluidized bed 10. The agitator may also be arranged so that it is situated within the fluidized bed 10. Such embodiments are shown in FIGS. 2 and 4.

The flotation cell 1 further comprises a recovery zone 20 arranged at the upper part 13 of the flotation cell, and configured to collect the bubble-particle agglomerates rising in the fluidized bed 10. The recovery zone 20 may be arranged above the fluidized bed. Alternatively, the recovery zone 20 may be arranged at an upper part 19 of the fluidized bed 10.

The bubble-particle agglomerates ascending in the fluidized bed 10 become transported to the recovery zone 20. The recovery zone 20 may comprise a froth layer 25 at the top of the flotation cell 1. The recovery zone 20 floats the bubble-particle agglomerates rising from the fluidized bed 10 to the froth layer 25. Alternatively, the recovery zone 20 may comprise no discernible froth layer, in which case the flotation cell is arranged to be operated with constant, and intentional, slurry overflow, i.e. as an overflow flotation cell.

A recovery launder 24 and the launder lip 26 are disposed at the top of the flotation cell 1, and arranged to remove particles collected in the recovery zone 20 as overflow 500 comprising a concentrate of desired (valuable) material. The recovery launder 24 may be a perimeter launder, with a launder lip 26 surrounding the perimeter 16 of the flotation cell 1, at the top of the flotation cell 1, over which launder lip 26 the collected particles flow into the recovery launder 24, as is known in the art.

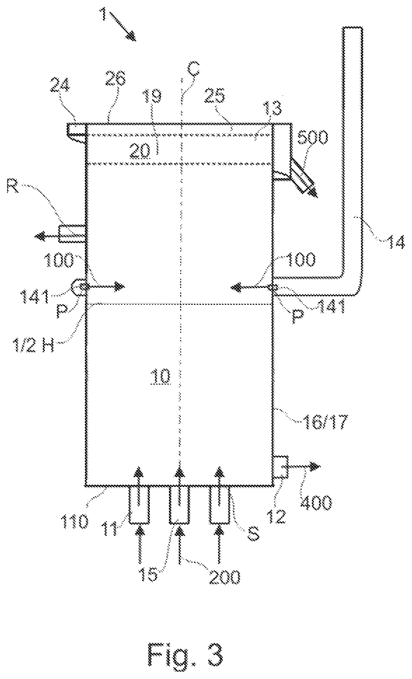

A tailings outlet 12 is arranged below the recovery launder 24, and arranged to remove non-collected particles descending from the recovery zone 20 as underflow 400. The tailings outlet 12 may arranged in the form of a perimeter tailings launder continuously surrounding the entire perimeter 16 of the flotation cell (FIGS. 1, 2). Alternatively, the tailings outlet 12 may be sectional, i.e. not continuous around the perimeter 16. In yet an alternative embodiment, the tailings outlet 12 may comprise a simple outlet or opening at the perimeter of the flotation cell 1 (FIGS. 3, 4 and 5a, 5b). The tailings outlet 12 may be located below the second feed inlet 15.

The primary slurry feed 100 comprises fresh slurry, which may originate from a grinding step or grinding arrangement, from underflow or tailings of another flotation cell or another part of a flotation arrangement or flotation line of which the flotation cell 1 is a part. In an embodiment, the primary slurry feed 100 comprises fresh slurry that has not been classified or fractioned after grinding. In an embodiment, the primary slurry feed 100 comprises coarse particles, for example ore particles having a P80 of 500-600 μm. In an embodiment, at least 20 w-% of the particles in the primary slurry feed 100 have a size of at least 300 μm.

The primary slurry feed 100 is fed into the flotation cell 1 by the first feed inlet 14. The primary slurry feed 100 is arranged to be fed into the flotation cell 1 at a first position P, which is located within an upper 50% ½H of the flotation cell height H, and higher than the tailings outlet 12. In an embodiment, the primary slurry feed 100 is arranged to be fed into the flotation cell 1 at a position P within an upper 30% of the flotation cell height H. In an embodiment, the primary slurry feed 100 is arranged to be fed into the recovery zone 20.

In an embodiment, the first feed inlet 14 is arranged at the centre C of the flotation cell 1, which is also the centre of the fluidized bed 10 and the recovery zone 20. In an embodiment, the first feed inlet 14 comprises a circular section 140 through which the primary slurry feed 100 is fed into the flotation cell 1. The circular section 140 encompasses the centre C of the flotation cell 1 and is arranged to distribute the primary slurry feed 100 evenly around the centre C of the flotation cell 1. The circular section 140 may for example comprise a circular trough or pipe/tube, which may have an open upper side, or comprise openings, so that the primary slurry feed 100 led into the circular section 140 may flow through the open upper side or the openings in a controlled manner.

In an embodiment, the primary slurry feed 100 is arranged to be fed into the flotation cell 1/fluidized bed 10 so that it has a flow direction counter-current to the rising bubble-particle agglomerates, as well as the direction of flow of the fluid fed into the fluidized bed 10 by the fluid feed 11 (see FIGS. 1, 2, 6). The first feed inlet 14 may comprise a sparger or a number of spargers. Any other suitable feed inlet such as a downcomer or a pipe or conduit may be used as the first feed inlet 14.

Alternatively, the primary slurry feed 100 may be arranged to be fed into the flotation cell 1/fluidized bed 10 from the perimeter 16 of the flotation cell 1 so that the primary slurry feed 100 has a flow direction substantially perpendicular to the rising bubble-particle agglomerates. Accordingly, the first feed inlet 14 may comprise a sparger assembly 141 arranged into a sidewall 17 of the flotation cell 1, the sparger assembly 141 arranged to create flotation gas bubbles, to cause attachment of flotation gas bubbles onto particles in the primary slurry feed 100, and to introduce the primary slurry feed 100 into the flotation cell 1/fluidized bed 10. The sparger assembly 141 may comprise a number of spargers arranged radially around the perimeter 16 of the flotation cell 1, so that each sparger is evenly spaced from each other.

The spargers may be cavitation spargers, jetting spargers or Venturi spargers, and thus the sparger assembly 141 and the first feed inlet 14 may comprise flotation gas feed.

The sparger assembly 141, i.e. the spargers, may also serve in generating flotation gas bubbles with an appropriate size distribution by injecting flotation gas into the primary slurry feed 100. For example, a jetting sparger (such as SonicSparger™ Jet), based on ultrasonic injection of air or air and water, may be utilized. Another example of a sparger is a cavitation or Venturi sparger (such as SonicSparger™ Vent), the operation of which is based on the Venturi principle which is highly efficient in generating large amount bubbles with relatively small size (0.3-0.9 mm). In a cavitation sparger, a recirculate of slurry from the flotation cell is forced through the sparger to generate bubbles through cavitation.

Also any other suitable type of feed inlets known in the art may be used as the first feed inlet 14.

The secondary slurry feed 200 comprises at least slurry recirculated from a flotation cell 1, 2. The secondary slurry feed 200 is arranged to be fed into the fluidized bed 10 by the second feed inlet 15, located at a second position S, which is arranged below the first position P. The secondary slurry feed 200 contributes to the formation of the fluidized bed 10.

The slurry recirculated from the flotation cell 1, i.e. the same flotation cell 1, is obtained at a third position R, which is located between the recovery launder 24 and the tailings outlet 12. In an embodiment, the third position R is arranged lower than the launder lip 26 and higher than the first position P at which the primary slurry feed 100 is arranged to be fed into the flotation cell 1. Alternatively, the slurry recirculated from the flotation cell 1 may be obtained at the third position R arranged lower than the first position P.

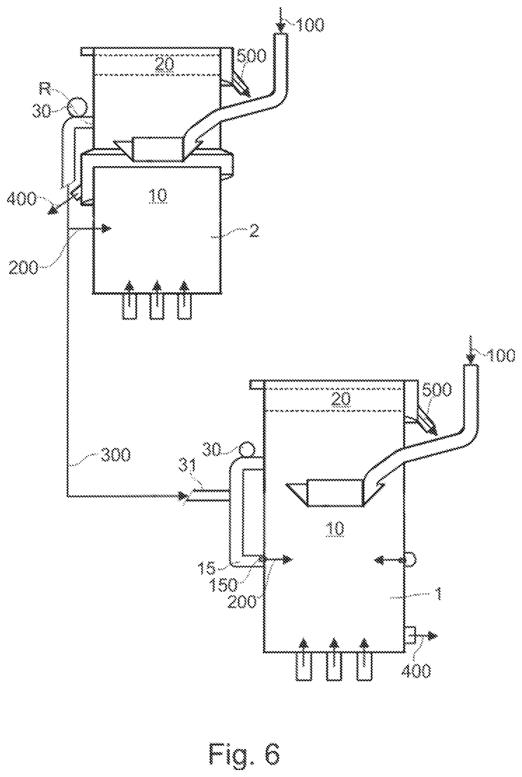

In an embodiment, alternatively or additionally, the secondary slurry feed 200 comprises slurry 300 recirculated from a further flotation cell 2, separate to the flotation cell 1 (FIG. 6). This recirculated slurry 300 may, for example, comprise a slurry fraction taken similarly from a position R of the further flotation cell 2, or it can comprise overflow or underflow from a further flotation cell, or a combination of overflow or underflows from several further flotation cells, and having a similar particle size distribution as the slurry in the fluidized bed 10 of the flotation cell 1.

In yet another embodiment, alternatively or additionally, the secondary slurry feed 200 may comprise a feed of slurry 300 from another part of the flotation line or flotation arrangement, for example from classification, fractionation or grinding. The feed of slurry 300 may, for example, be fresh slurry similar to the fresh slurry comprised by the primary slurry feed 100.

In general, recirculating slurry in the manner as described in connection with the secondary feed 200, it may be possible to control the mass balance of the flotation cell 1 in an efficient manner.

In an embodiment, the secondary slurry feed 200 comprises fine particles having a P80 50% or less of the P80 of the primary slurry feed 100. For example, the secondary slurry feed 200 may comprise fine particles having a P80 of approximately 200 μm.

The secondary slurry feed 200 is fed into the flotation cell 1, into the fluidized bed 10 by the second feed inlet 15. The secondary slurry feed 200 contributes to the formation of the fluidized bed 10, and may thus decrease the need of fresh water in the fluid via the fluid feed 11. The secondary slurry feed 200 may have a flow direction divergent from the rising bubble-particle agglomerates in the flotation cell 1. Alternatively, the secondary slurry feed 200 may have a flow direction concurrent with the rising bubble-particle agglomerates.

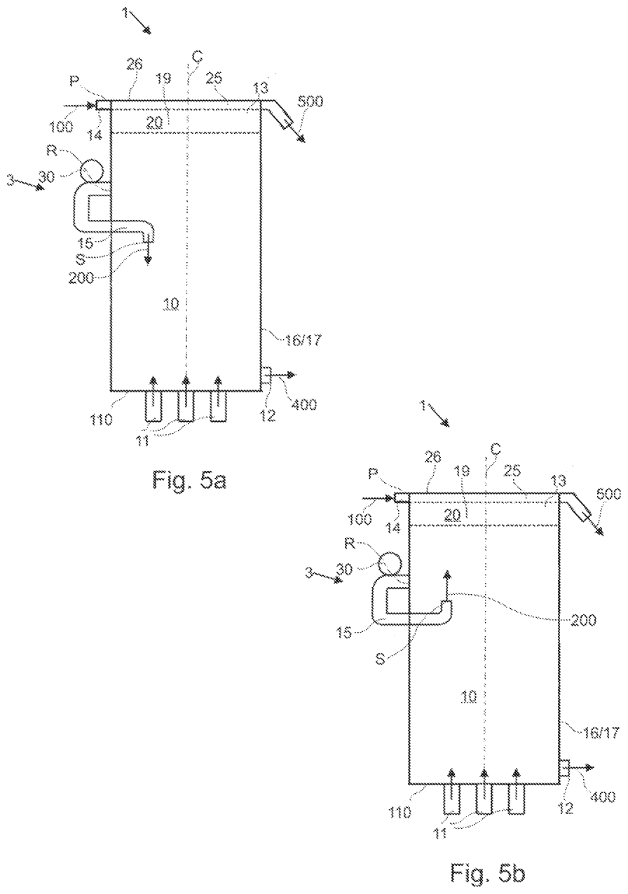

In an embodiment, the secondary slurry feed 200 is arranged to be fed into the flotation cell 1/fluidized bed 10 so that the secondary slurry feed 200 has a flow direction counter-current to the rising bubble-particle agglomerates (see FIGS. 4, 5a), as well as the direction of flow of the fluid fed into the flotation cell 1 by the fluid feed 11. The second feed inlet 15 may comprise a sparger or a number of spargers. Any other suitable feed inlet such as a downcomer or a pipe or conduit may be used as the second feed inlet 15.

In an alternative embodiment, the secondary slurry feed 200 is arranged to be fed into the flotation cell 1/fluidized bed 10 from the perimeter 16 of the flotation cell 1 so that the flow direction of the secondary slurry feed 200 is substantially perpendicular to the rising bubble-particle agglomerates (see FIGS. 1, 2). In this case, the second feed inlet 15 may comprise a number of feed openings 150 arranged into a sidewall 17 of the flotation cell 1. The feed openings 150 may be arranged into the sidewall 17 evenly distributed along the perimeter 16 of the flotation cell 1 so as to form a circle or gird of evenly-spaced apart feed openings 150. Also in this case, the feed openings may comprise spargers, similarly to the solutions presented in connection with the first feed inlet 14.

In a yet another alternative embodiment, the secondary slurry feed 200 is arranged to be fed into the flotation cell 1/fluidized bed 10 so that the secondary slurry feed 200 has a flow direction concurrent to the rising bubble-particle agglomerates (see FIGS. 3, 5b). For example the second feed inlet 15 may be incorporated with the fluid feed 11, i.e. the second feed inlet 15 comprises the fluid feed 11, as is shown in FIG. 3, and the secondary slurry feed 200 fed into the flotation cell 1/fluidized bed 10 from the bottom 110 of the flotation cell 1. It is also possible that the second feed inlet 15 comprises the fluid feed 11 also in the embodiments where the flow direction of the secondary slurry feed 200 is divergent from the rising bubble-particle agglomerates, i.e. also when the second feed inlet 15 is arranged as shown in FIG. 1, 2, 4 or 5a. In some cases, it may be possible to significantly reduce the amount of fluid needed to maintain the fluidized bed 10 due to the employment of secondary slurry feed 200 in this purpose, in the manner described above.

In all of the above embodiments, the second feed inlet 15 and/or the feed openings 150 may comprise for example spargers, such as cavitation spargers, jetting spargers or Venturi spargers, and thus the feed openings 150 (and the second feed inlet 15) may comprise flotation gas feed.

The feed openings 150, such as spargers, may also serve in generating flotation gas bubbles with an appropriate size distribution by injecting flotation gas into the secondary slurry feed 200. For example, a jetting sparger (such as SonicSparger™ Jet), based on ultrasonic injection of air or air and water, may be utilized. Another example of a sparger is a cavitation or Venturi sparger (such as SonicSparger™ Vent), the operation of which is based on the Venturi principle which is highly efficient in generating large amount bubbles with relatively small size (0.3-0.9 mm). In a cavitation sparger, a recirculate of slurry from the flotation cell is forced through the sparger to generate bubbles through cavitation.

Also any other suitable type of feed inlets known in the art may be used as the second feed inlet 15 and/or feed openings 150.

The secondary slurry feed 200 comprising slurry recirculated from the flotation cell 1 may be recirculated via a recirculation circuit 3. The recirculation circuit 3 may comprise a pump 30 arranged to intake a slurry fraction from the third position R, and to forward the slurry fraction into the second feed inlet 15 as secondary slurry feed 200, or as a part of the secondary slurry feed 200.

In an embodiment, the recirculation circuit 3 comprises a third feed inlet 31 for introducing a feed of slurry 300 into the secondary slurry feed 200 prior to the secondary slurry feed 200 being fed into the flotation cell 1 via the second feed inlet 15. As described above, the feed of slurry 300 may comprise any suitable additional fraction of slurry taken from another part of a flotation line or arrangement of which the flotation cell 1 is a part.

In an embodiment, the primary slurry feed 100 is arranged to be fed into the froth layer 25 of the flotation cell 1, i.e. the first position P at which the primary slurry feed 100 is introduced into the flotation cell 1 is arranged at the upper part 13 of the flotation cell, right at the height of the froth layer 25 (see FIGS. 5a and 5b). The first feed inlet 15 may, for example be arranged at one point at the perimeter 16 of the flotation cell 1. The recovery launder 24, in this case, may be an outlet arranged at another point at the perimeter 16, for example substantially opposite the first feed inlet 15. The secondary slurry 200 comprises slurry recirculated from the flotation cell 1 via a recirculation circuit 3, and obtained at the third position R which is arranged lower than the first position P. The secondary slurry feed 200 may have a flow direction divergent (counter-current, perpendicular) from the rising bubble-particle agglomerates (FIG. 5a), or a flow direction concurrent with the rising bubble-particle agglomerates (FIG. 5b).

The flotation cell 1 may have circular cross-section. The flotation cell 1 may have a diameter of at least 1.0 m, measured at the height of the second position S. The flotation cell 1 may have a diameter of over 2 m. The flotation cell may have a diameter between 2 to 8 m, for example 2.25 m; 3.5 m; 5 m; 6.75 m; or 7.8 m. The flotation 1 may also have a cross-section that is divergent from circular, e.g. rectangular or square. In case the cross-section is not circular, the diameter is measured as the maximum diagonal of the cross-sectional form.

The flotation cell 1 may have a substantially level bottom. The manner of feeding the primary slurry feed 100 and the secondary slurry feed 200 into the flotation cell 1 may help in minimizing the build-up of sediment at the bottom 110 of the flotation cell 1. Therefore no special solutions, such as conical, slanting or funnel-like bottom structures may be required, as may be the case in conventional fluidized bed flotation cells. Further, it may be possible to avoid arranging a cleaning hatch or other maintenance constructions at the bottom 110 of the flotation cell 1, thereby making its constructions easier and more cost-effective. Naturally also the need of performing maintenance operations may be decreased, thereby reducing operational costs.

The flotation cell 1 as defined above may be used in recovering a valuable material suspended in slurry. In a further embodiment, the use is specifically directed to recovering particles comprising copper from low grade ore.

According to another aspect of the invention, the method for treating particles suspended in slurry and for separating the slurry into underflow 400 and overflow 500 in a flotation cell 1 as described above comprises feeding a primary slurry feed 100 comprising fresh slurry into the flotation cell 1 via a first feed inlet 14; and feeding a secondary slurry feed 200 comprising at least slurry recirculated from a flotation cell 1, 2 into the fluidized bed 10 via a second feed inlet 15 so as to contribute to the formation of the fluidized bed F, the slurry recirculated from the flotation cell 1 at a third position R between the recovery launder 24 and the tailings outlet 12.

The primary slurry feed 100 may be fed at the centre C of the flotation cell 1, so that the primary slurry feed 100 is distributed evenly around the centre C. The primary slurry feed 100 may be fed into the flotation cell 1 so that it has a flow direction counter-current to the rising bubble-particle agglomerates, for example by a sparger, as explained above. Alternatively, the primary slurry feed 100 may be fed into the flotation cell 1 from its perimeter 16 so that the primary slurry feed has a flow direction substantially perpendicular to the rising bubble-particle agglomerates. The primary slurry feed may be arranged to be fed on top of the fluidized bed 10, in the froth layer 25.

The secondary slurry feed 200 may be fed into the fluidized bed 10 so that it has a flow direction counter-current to the rising bubble-particle agglomerates. In an alternative embodiment, the secondary slurry feed 200 is fed into the fluidized bed 10 from the perimeter 16 of the flotation cell 1 so that it has a flow direction substantially perpendicular to the rising bubble-particle agglomerates. In yet another alternative embodiment, the secondary slurry feed 200 is fed into the fluidized bed 10 so that it has a flow direction concurrent with the rising bubble-particle agglomerates.

The embodiments described hereinbefore may be used in any combination with each other. Several of the embodiments may be combined together to form a further embodiment. A flotation cell, a use or a method, to which the disclosure is related, may comprise at least one of the embodiments described hereinbefore. It is obvious to a person skilled in the art that with the advancement of technology, the basic idea of the invention may be implemented in various ways. The invention and its embodiments are thus not limited to the examples described above; instead they may vary within the scope of the claims.

1. A flotation cell for treating particles suspended in slurry and for separating the slurry into underflow and overflow, the flotation cell comprising
a fluidized bed formed by fluid feed configured to supply a fluid to the flotation cell, and by a flotation gas feed configured to supply flotation gas, in which fluidized bed flotation gas bubbles adsorb to hydrophobic particles to form bubble-particle agglomerates that rise towards the top of the flotation cell;
a recovery zone at an upper part of the flotation cell, configured to collect the bubble-particle agglomerates rising in the fluidized bed;
a launder lip and a recovery launder arranged at the top of the flotation cell, and arranged to remove particles collected in the recovery zone from the flotation cell as overflow; and
a tailings outlet arranged below the recovery launder and arranged to remove non-collected particles descending from the recovery zone as underflow;
wherein the flotation cell has a height measured from the bottom of the flotation cell to the launder lip, wherein
a primary slurry feed comprising fresh slurry is arranged to be fed into the flotation cell by a first feed inlet at a first position within an upper 50% of the flotation cell height and higher than the tailings outlet; and in that
a secondary slurry feed comprising at least slurry recirculated from a flotation cell is arranged to be fed into the fluidized bed by a second feed inlet at a second position below the first position, so as to contribute to the formation of the fluidized bed, the slurry recirculated from the flotation cell obtained at a third position between the recovery launder and the tailings outlet.

2. The flotation cell according to claim 1, wherein the recovery zone is arranged above the fluidized bed.

3. The flotation cell according to claim 1, wherein the recovery zone is arranged at an upper part of the fluidized bed.

4. The flotation cell according to claim 1, wherein the primary slurry feed is arranged to be fed into the flotation cell at a position within an upper 30% of the flotation cell height.

5. The flotation cell according to claim 1, wherein the primary slurry feed is arranged to be fed into the recovery zone.

6. The flotation cell according to claim 1, wherein the first feed inlet is arranged at the centre of the flotation cell.

7. The flotation cell according to claim 6, wherein the first feed inlet comprises a circular section arranged to distribute the primary slurry feed evenly around the centre of the flotation cell.

8. The flotation cell according to claim 1, wherein the primary slurry feed is arranged to be fed into the fluidized bed so that the primary slurry feed has a flow direction counter-current to the rising bubble-particle agglomerates.

9. The flotation cell according to claim 8, wherein the first feed inlet comprises a sparger.

10. The flotation cell according to claim 1, wherein the primary slurry feed is arranged to be fed into the fluidized bed from a perimeter of the flotation cell so that the primary slurry feed has a flow direction substantially perpendicular to the rising bubble-particle agglomerates.

11. The flotation cell according to claim 10, wherein the first feed inlet comprises a sparger assembly arranged into a sidewall of the flotation cell, the sparger assembly arranged to create flotation gas bubbles, to cause attachment of flotation gas bubbles onto particles in the primary slurry feed, and to introduce the primary slurry feed into the fluidized bed.

12. The flotation cell according to claim 11, wherein the sparger assembly is arranged radially around a perimeter of the flotation cell.

13. The flotation cell according to claim 11, wherein the sparger assembly comprises jetting spargers, or cavitation spargers, or Venturi spargers.

14. The flotation cell according to claim 1, wherein the fluid feed comprises flotation gas feed.

15. The flotation cell according to claim 1, wherein the second feed inlet comprises flotation gas feed.

16. The flotation cell according to claim 1, wherein the secondary slurry feed is arranged to be fed into the fluidized bed so that the secondary slurry feed has a flow direction counter-current to the rising bubble-particle agglomerates.

17. The flotation cell according to claim 16, wherein the second feed inlet comprises a sparger.

18. The flotation cell according to claim 1, wherein the secondary slurry feed is arranged to be fed into the fluidized bed from the perimeter of the flotation cell so that the secondary slurry feed has a flow direction substantially perpendicular to the rising bubble-particle agglomerates.

19. The flotation cell according to claim 18, wherein the second feed inlet comprises a number of feed openings arranged into the sidewall of the flotation cell.

20. The flotation cell according to claim 1, wherein the secondary slurry feed is arranged to be fed into the fluidized bed so that it has a flow direction concurrent to the rising bubble-particle agglomerates.

21. The flotation cell according to claim 1, wherein the second feed inlet comprises the fluid feed.

22. The flotation cell according to claim 1, wherein secondary slurry feed comprises slurry recirculated from the flotation cell via a recirculation circuit, and obtained at the third position which is arranged lower than the launder lip and higher than the first position at which the primary slurry feed is arranged to be fed into the flotation cell.

23. The flotation cell according to claim 1, wherein the secondary slurry feed comprises slurry recirculated from the flotation cell via a recirculation circuit, and obtained at the third position which is arranged lower than the first position.

24. The flotation cell according to claim 1, wherein the recovery zone comprises a froth layer at the top of the flotation cell.

25. The flotation cell according to claim 23, wherein the primary slurry feed is arranged to be fed into the froth layer.

26. The flotation cell according to claim 1, wherein the recovery zone comprises no froth layer and that the flotation cell is arranged to be operated with constant slurry overflow.

27. The flotation cell according to claim 22, wherein the recirculation circuit comprises a pump arranged to intake a slurry fraction from the third position and to forward the slurry fraction into the second feed inlet as secondary slurry feed.

28. The flotation cell according to claim 22, wherein the recirculation circuit comprises a third feed inlet for introducing a feed of slurry into the secondary slurry feed prior to the secondary slurry feed being fed into the flotation cell via the second feed inlet.

29. The flotation cell according to claim 1, wherein the secondary slurry feed comprises slurry recirculated from a further flotation cell separate to the flotation cell.

30. The flotation cell according to claim 1, wherein the tailings outlet is arranged below the second feed inlet.

31. The flotation cell according to claim 1, wherein the secondary slurry feed comprises fine particles having a P80 50% or less of the P80 of the primary slurry feed.

32. The flotation cell according to claim 1, wherein the primary slurry feed comprises at least 20 w-% particles having a size of at least 300 μm.

33. The flotation cell according to claim 1, wherein it has a diameter of at least 1.0 m, preferably over 2 m, and most preferably between 2 and 8 m, at the height of the second position.

34. Use of the flotation cell according to claim 1 in recovering a valuable material suspended in slurry.

35. The use according to claim 34, in recovering particles comprising Cu from low grade ore.

36. A method for treating particles suspended in slurry and for separating the slurry into underflow and overflow in a flotation cell according to claim 1, wherein
feeding a primary slurry feed comprising fresh slurry into the flotation cell via a first feed inlet;
feeding a secondary slurry feed comprising at least slurry recirculated from a flotation cell into a fluidized bed via a second feed inlet so as to contribute to the formation of the fluidized bed; and by
obtaining the slurry recirculated from the flotation cell at a third position between a recovery launder and a tailings outlet.
